(19) United States
(12) Patent Application Publication
(10) Pub. No.: US 2018/0232766 A1
(43) Pub. Date: Aug. 16, 2018

(54) SYSTEM AND METHOD OF TRANSMITTING TARGETED CONTENT TO AN END USER DEVICE

(71) Applicant: Vision Works IP Corporation, Sequim, WA (US)

(72) Inventor: Fritz Braunberger, Sequim, WA (US)

(21) Appl. No.: 15/431,257

(22) Filed: Feb. 13, 2017

(51) Int. Cl. G06Q 30/02; H04M 1/725; H04W 4/02

(52) U.S. Cl. CPC G06Q 30/0261; H04M 1/72544; G06Q 30/0252; H04W 4/023; G06Q 30/0255

(57) ABSTRACT

A system for transmitting targeted content to an end user device comprises a program stored on the end user device configured to receive the targeted content, a location sensor configured to sense a location of the end user device, and a server for storing the targeted content, wherein the server is configured to transmit the targeted content to the end user device when the end user device is at one or more specific locations. Targeted content, such as coupons, promotions and special offers are able to be transmitted to an end user device based on a location of the end user device. The content is able to be digital in nature and may be animations, video, audio, static images, and/or documents. An end user is able to opt-in and/or opt-out of receiving the targeted content at the user device.

### FIELD OF THE INVENTION

The present invention is generally directed to marketing and advertising systems and methods. More specifically, the present invention is directed to a system for and method of transmitting targeted content to an end user device.

### BACKGROUND OF THE INVENTION

Targeted advertising is a form of advertising that focuses on certain traits of the consumer and based on the product or person the advertiser is promoting. Targeted advertising displays may be located in areas where consumers with those traits are likely to come upon the advertisement. However, especially concerning physical displays, it is difficult to determine a proper placement and timing of the display so that the targeted consumer sees the advertisement.

### SUMMARY OF THE INVENTION

A system for and method of transmitting content to an end user device comprises a program stored on the end user device configured to receive the targeted content, a location sensor configured to sense a location of the end user device, and a server for storing the targeted content, wherein the server is configured to transmit the targeted content to the end user device when the end user device is at one or more specific locations. Targeted content, such as coupons, promotions and special offers are able to be transmitted to an end user device based on a location of the end user device. The content is able to be digital in nature and may be animations, video, audio, static images, and/or documents. An end user is able to opt-in and/or opt-out of receiving the targeted content at the user device.

In one aspect, a system for transmitting targeted content to an end user device comprise a program stored on the end user device configured to receive the targeted content, a location sensor configured to sense a location of the end user device, and a server for storing the targeted content, wherein the server is configured to transmit the targeted content to the end user device when the end user device is at one or more specific locations deemed beneficial for marketing reasons. In some embodiments, the one or more locations comprises one of an indoor location and an outdoor location. In some embodiments, the end user device comprises, one of a tablet, a smartphone and a smart watch. The targeted content is able to be displayed as one of animation, video and audio. In some embodiments, targeted content is related to the location of the end user device. In some of these embodiments, the targeted content comprises one of a coupon, voucher, a special offer, and a specific offer to an end user based on end user's data mined information. In further embodiments, the targeted content comprises information regarding an upcoming event. In some embodiments, the targeted content is assembled in real time based on data mined information. In some embodiments, once the location sensor has sensed an opted-in end user is in proximity, the server seeks third party data mined information specific to that end user in real time from third parties and assembles a message. In some embodiments, the targeted content is uploaded to the server by an advertiser. In some embodiments, the targeted content comprises ads personalized to the identity and specifics of the end user. In some embodiments, the location sensor comprises one of a Geo-based, a GNSS based, and a GPS based location sensor. In some embodiments, the location sensor comprises a wireless signal detector wherein the end user device alerts the wireless signal detector when the end user device is in proximity. In some embodiments, the location sensor comprises a non-GPS proximity sensor. In some embodiments, the specific location is sensed base upon triangulation of an omni-directional RF signal. In some embodiments, a localized ping is used for triangulation.

In another aspect, a system for connecting targeted content with an end user comprises a user interface for uploading one or more user preferences to a server, a provider interface for uploading one or more provider preferences to the server, and the server, wherein the server is configured to transmit targeted content to an end user device based on the one or more user preferences and the one or more provider preferences. In some embodiments, a user is able to opt-in and opt-out of receiving the targeted content. In some embodiments, the end user device comprises a program which is used to upload the one or more user preferences to the server. In some embodiments, the user preferences make sure that the user only receives wanted content. In some embodiments, the provider interface enables a content provider to the upload a content description to allow users to opt-in to receive its targeted content. In further embodiments, the provider interface enables a content provider to select one or more of a geographic area, age, sex and other user attributes for distributing its content. In some embodiments, the provider interface enables a content provider to determine the geographic constructs of its targeted content such that the content is sent to one or more end users when the users are at a predetermined geographic location.

In a further aspect, a method of transmitting targeted content to an end user device, comprises sensing a location of the end user device and based on the location of the end user device, transmitting the targeted content to the end user device. In some embodiments, the end user device comprises, one of a tablet, a smartphone, a smart watch, and a smart device within a rental car. In some embodiments, the targeted content is displayed as one of animation, video and audio. In further embodiments, the targeted content is related to the location of the end user device. In some embodiments, the targeted content comprises one of a coupon, voucher and a special offer. In some embodiments, the targeted content comprises information regarding an upcoming event. In further embodiments, the targeted content is uploaded to the server by a content provider. In some embodiments, the location is sensed with one of a Geo-based, a GNSS based, and a GPS based location sensor. In some embodiments, the location is sensed by a wireless signal detector wherein the end user device alerts the wireless signal detector when the end user device is in proximity.

In still a further aspect, a method of transmitting targeted content to an end user device comprises sensing a location of an end user based on a location of an end user device, seeking third party data mined information specific to that end user from third parties, assembling a message based on the data mined information specific to the end user, and sending the message to the end user device. In some embodiments, the third party data is sought in real time from the third parties. In some embodiments, the third party data comprises dated based on one or more applications running on the end user device.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates a system for transmitting targeted content to an end user device, in accordance with some embodiments.

FIG. 2 illustrates system for connecting targeted content with an end user, in accordance with some embodiments.

FIG. 3 illustrates a method of transmitting targeted content to an end user device, in accordance with some embodiments.

FIG. 4 illustrates a method of transmitting targeted content to an end user device in accordance with some embodiments.

### DETAILED DESCRIPTION OF THE EMBODIMENTS:

Embodiments of the invention are directed to a system for a method of transmitting targeted content to an end user device. The system comprises a program stored on the end user device is configured to receive the targeted content, a location sensor configured to sense a location of the end user device, and a server for storing the targeted content, wherein the server is configured to transmit the targeted content to the end user device when the end user device is at one or more locations. Targeted content, such as coupons, promotions and special offers are able to be transmitted to an end user device based on a location of the end user device. The content is able to be digital in nature and may be animations, video, audio, static images, and/or documents. An end user is able to opt-in and/or opt-out of receiving the targeted content at the user device.

Reference will now be made in detail to implementations of a system for an method of transmitting targeted content to an end user device. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

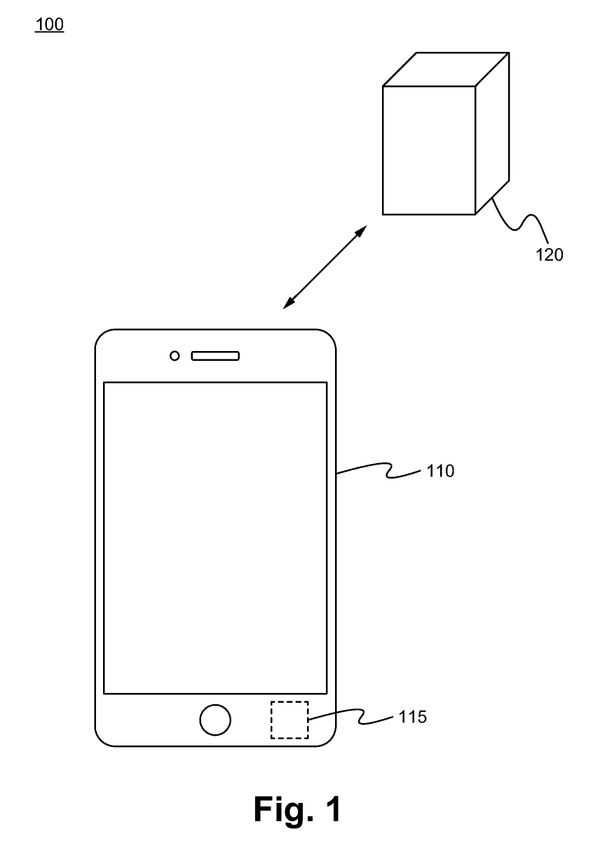

Referring now to FIG. 1, a system for transmitting targeted content to an end user device is depicted therein. The system 100 comprises an end user device 110, a location sensor 115 and a server 120 in communication with the end user device 110 and the location sensor 115. The location sensor 115 is configured to sense a location of the end user device 110 and send a signal to the server 120 based on a location of the end user device 110. The server 120 is configured to transmit targeted content to the end user device 110 based on the location of the end user device 110. Particularly, the server 120 is configured to transmit targeted content to the end user device 110 when the end user device 110 is at one or more geographic locations. For example, in some embodiments, the specific location may be a location deemed beneficial for marketing reasons.

In some embodiments, the end user device 110 comprises one of a tablet, a smart phone, and a smart watch. However, the end user device 100 is able to comprise any appropriately formatted device configured to receive information. For example, in some embodiments, the end user device 110 comprises a smart device within a rental car. In some embodiments, the location sensor 115 comprises a Geo-based, a GNSS based, and a GPS based location sensor. However, the location sensor 115 is able to comprise any appropriately desired locations sensor 115. For example, in some embodiments, the location sensor 115 comprises a wireless signal detector wherein the end user device alerts the wireless signal detector when the end user device is in proximity. In some embodiments, the location sensor 115 senses a location based upon triangulation of an omni-directional RF signal. In some embodiments a localized ping is used for triangulation. In some embodiments, the location sensor 115 is an integral component of the end user device 110. Alternatively, in some embodiments, the location sensor 115 comprises an add-on component of the end user device 110. In some embodiments, the server 120 comprises a cloud-based storage server.

In some embodiments, the server 120 is configured to send targeted content to the end user device 110 based on one or more user defined preferences as indicated by the program stored on the end user device 110. For example, in some embodiments, a user is able to opt-in or opt-out of receiving the targeted content. As described above, the server 120 is configured to send targeted content to the end user device 110 based on a location of the end user device 110. For example, in some embodiments, the location sensor 115 senses that the end user device 110 is at an outdoor location such as a park or a lake and sends a signal to the server 120 based on the location of the end user device 110. In response the server 120 is able to transmit targeted content such as maps, regulations or other information to the end user device 110. Alternatively, in some embodiments, the location sensor 115 senses that the end user device 110 is at an indoor location such as a museum or other indoor location and sends a signal to the server 120 based on the location of the end user device 110. In response the server 120 is able to transmit targeted content such as maps, regulations or other information to the end user device 110. The server 102 is able to send digital content such as animations, video, audio, static images, and/or documents to the end user device 110. In some embodiments, the targeted content comprises ads personalized to the identity and specifics of the end user.

In some embodiments, the targeted content comprises a special offer such as a coupon or a voucher for a nearby business. Particularly, businesses and/or advertisers are able to upload content such as special offers, coupons, vouchers, and upcoming events to the server 120. Then, when the server receives a signal from the location sensor 115 of the end user device 110 that the device 110 is near the business, the server 120 is able to send the uploaded content to the end user device 110. In this manner, the businesses and advertisers are able to target potential customers as the customer is already in a location near to the business and thus more likely to visit the business.

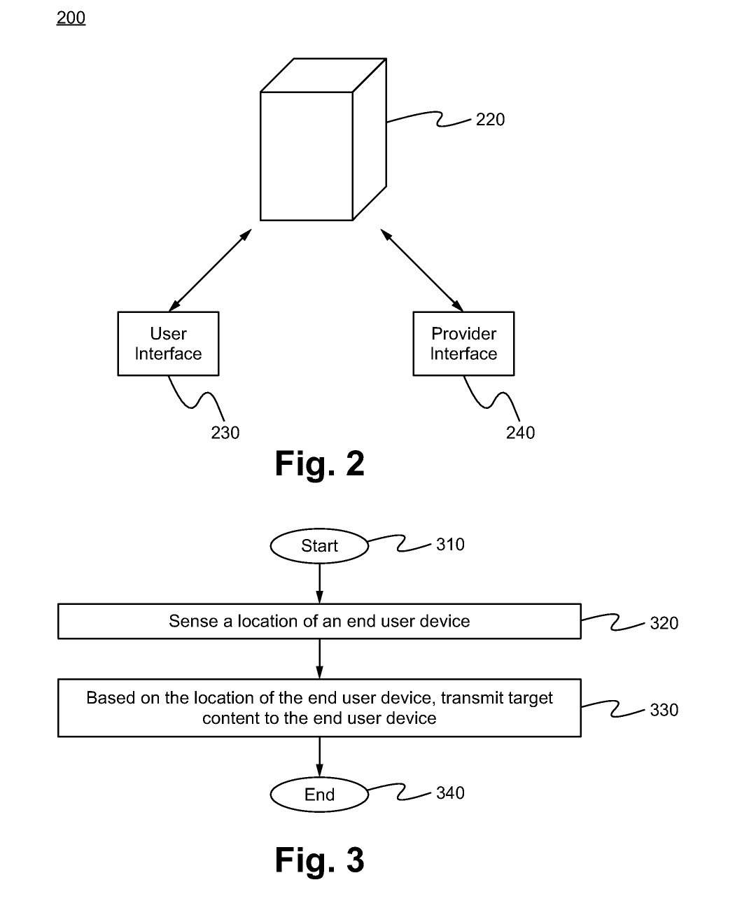

FIG. 2 illustrates a system for connecting targeted content with an end user. The system 200 comprises a user interface 230 for uploading one or more user preferences to a server 220, a provider interface 240 for uploading one or more provider preferences to the server 220, and the server for storing the one or more user preferences and the one or more provider preferences. In some embodiments, a user uploads their preferences using a program stored on an end user device 110, such as described above. For example, in some embodiments, a user is able to opt-in or opt-out of receiving the targeted content, such as described above. In some embodiments, a user is able to direct the type of content that they are able to receive at their end user device. For example, the user can create a list of interests and other information such that the user only receives wanted content.

Similarly, a content provider, such as a business or advertiser is able to use the provider interface 230 to connect to users. For example, the content provider is able to upload a business description to allow users to opt-in to receive its targeted content. Alternatively or in conjunction, the content provider is able to select a geographic area, age, sex or other user attributes for distributing its content. The content provider is also able to determine the geographical constructs of its targeted content such that the content is sent to one or more end users when the users are at a predetermined location. The content provider is then able to upload the targeted content to the server 220 so that the server 220 sends targeted content to an end user device when the end user device is at a predetermined location.

FIG. 3 illustrates a method of transmitting targeted content to an end user device. The method begins in the step 310. In the step 320, a location of an end user device is sensed. As described above, in some embodiments, the end user device comprises one of a tablet, a smart phone, and a smart watch. However, the end user device is able to comprise any appropriately formatted device configured to receive information. In some embodiments, the location of the end user device is sensed using a location sensor coupled to the end user device. For example, in some embodiments, the location sensor comprises a Geo-based, a GNSS based, and a GPS based location sensor. For example, in some embodiments, the location is sensed by a wireless signal detector wherein the end user device alerts the wireless signal detector when the end user device is in proximity. In some embodiments, a location is sensed based upon triangulation of an omni-directional RF signal. In some embodiments a localized ping is used for triangulation. However, the location sensor is able to comprise any appropriately desired location sensor 115. In some embodiments, the location sensor is an integral component of the end user device 110. Alternatively, in some embodiments, the location sensor comprises an add-on component of the end user device. In the step 330, based on the location of the end user device targeted content in transmitted to the end user device. As described above, in some embodiments, the targeted content comprises a special offer such as a coupon or a voucher for a nearby business. Alternatively, or in conjunction, the targeted content comprises information regarding an upcoming event. In some embodiments, the targeted content relates to a location of the end user device. As described above, the targeted content is able to be uploaded to a server by a content provider such as a business and/or an advertiser. The method ends in the step 340.

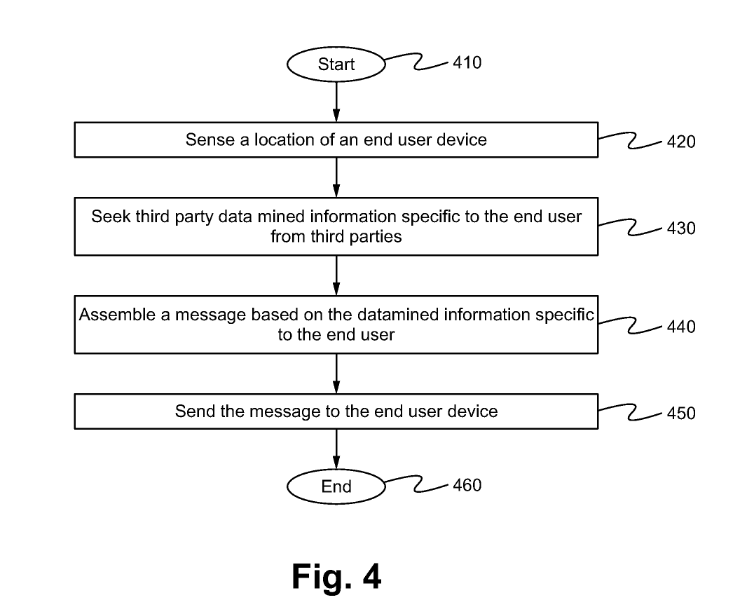

Referring now to FIG. 4, a method of transmitting targeted content to an end user device is depicted therein. The method begins in the step 410. In the step 420, a location of an end user is sensed based on a location of an end user device. As described above, in some embodiments, the end user device comprises one of a tablet, a smart phone, and a smart watch. However, the end user device is able to comprise any appropriately formatted device configured to receive information. In some embodiments, the location of the end user device is sensed using a location sensor coupled to the end user device. In the step 430, third party data mined information specific to that end user is searched from third parties. In some embodiments, the third party data is sought in real time from the third parties. In some embodiments, the third party data comprises dated based on one or more applications running on the end user device. Then, in the step 440, a message is assembled based on the data mined information specific to the end user and in the step 450 the message is sent to the end user device. The method ends in the step 460.

In operation, targeted content, such as coupons, promotions and special offers are able to be transmitted to an end user device based on a location of the end user device. The content is able to be digital in nature and may be animations, video, audio, static images, and/or documents. An end user is able to opt-in and/or opt-out of receiving the targeted content at the user device. Additionally, the user is able tailor the targeted content that they wish to receive. The content is sent to the user device from a server, such as a cloud based server. Content is uploaded by a content provider such as a business and/or an advertiser and only appear when a user who has opted-in to the service is in proximity to a pre-determined geographical location. Additionally, end users as well as content providers are able to customize the content that is received at and sent to the end user device. As such, the system and method as described herein have many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A system for transmitting targeted content to an end user device, the system comprising:
a. a program stored on the end user device configured to receive the targeted content;
b. a location sensor configured to sense a location of the end user device; and
c. a server for storing the targeted content, wherein the server is configured to transmit the targeted content to the end user device when the end user device is at one or more specific locations deemed beneficial for marketing reasons.

2. The system of claim 1, wherein the one or more locations comprises one of an indoor location and an outdoor location.

3. The system of claim 1, wherein the end user device comprises, one of a tablet, a smartphone and a smart watch.

4. The system of claim 1, wherein the targeted content is displayed as one of animation, video and audio.

5. The system of claim 1, wherein the targeted content is related to the location of the end user device.

6. The system of claim 5, wherein the targeted content comprises one of a coupon, voucher, a special offer, and a specific offer to an end user based on end user's data mined information.

7. The system of claim 5, wherein the targeted content comprises information regarding an upcoming event.

8. The system of claim 1, wherein the targeted content is assembled in real time based on data mined information.

9. The system of claim 1, wherein once the location sensor has sensed an opted-in end user is in proximity, the server seeks third party data mined information specific to that end user in real time from third parties and assembles a message.

10. The system of claim 1, wherein the targeted content is uploaded to the server by an advertiser.

11. The system of claim 1, wherein the targeted content comprises ads personalized to the identity and specifics of the end user.

12. The system of claim 1, wherein the location sensor comprises one of a Geo-based, a GNSS based, and a GPS based location sensor.

13. The system of claim 1, wherein the location sensor comprises a wireless signal detector wherein the end user device alerts the wireless signal detector when the end user device is in proximity.

14. The system of claim 1, wherein the location sensor comprises a non-GPS proximity sensor.

15. The system of claim 1, wherein the location sensors senses a specific location based on triangulation of an omni-directional RF signal.

16. The system of claim 15, wherein a localized ping is used for triangulation.

17. A system for connecting targeted content with an end user, the system comprising:
a. a user interface for uploading one or more user preferences to a server;
b. a provider interface for uploading one or more provider preferences to the server; and
c. the server, wherein the server is configured to transmit targeted content to an end user device based on the one or more user preferences and the one or more provider preferences.

18. The system of claim 17, wherein a user is able to opt-in and opt-out of receiving the targeted content.

19. The system of claim 17, wherein the end user device comprises a program which is used to upload the one or more user preferences to the server.

20. The system of claim 17, wherein the user preferences make sure that the user only receives wanted content.

21. The system of claim 17, wherein the provider interface enables a content provider to the upload a content description to allow users to opt-in to receive its targeted content.

22. The system of claim 17, wherein the provider interface enables a content provider to select one or more of a geographic area, age, sex and other user attributes for distributing its content.

23. The system of claim 17, wherein the provider interface enables a content provider to determine the geographic constructs of its targeted content such that the content is sent to one or more end users when the users are at a predetermined geographic location.

24. A method of transmitting targeted content to an end user device, the method comprising:
a. sensing a location of the end user device; and
b. based on the location of the end user device, transmitting the targeted content to the end user device.

25. The method of claim 24, wherein the end user device comprises, one of a tablet, a smartphone, a smart watch, and a smart device within a rental car.

26. The method of claim 24, wherein the targeted content is displayed as one of animation, video and audio.

27. The method of claim 24, wherein the targeted content is related to the location of the end user device.

28. The method of claim 24, wherein the targeted content comprises one of a coupon, voucher and a special offer.

29. The method of claim 24, wherein the targeted content comprises information regarding an upcoming event.

30. The method of claim 24, wherein the targeted content is uploaded to the server by a content provider.

31. The method of claim 24, wherein the location is sensed with one of a Geo-based, a GNSS based, and a GPS based location sensor.

32. The method of claim 24, wherein the location is sensed by a wireless signal detector wherein the end user device alerts the wireless signal detector when the end user device is in proximity.

33. The method of claim 24, wherein the location is sensed by a non-GPS proximity sensor.

34. A method of transmitting targeted content to an end user device, the method comprising:
a. sensing a location of an end user based on a location of an end user device; and
b. seeking third party data mined information specific to that end user from third parties;
c. assembling a message based on the data mined information specific to the end user; and
d. sending the message to the end user device.

35. The method of claim 34, wherein the third party data is sought in real time from the third parties.

36. The method of claim 34, wherein the third party data comprises dated based on one or more applications running on the end user device.
